(19) United States
(12) Patent Application Publication
(10) Pub. No.: US 2026/0116899 A1
(43) Pub. Date: Apr. 30, 2026

(54) EXCHANGE RESINS FOR IMPURITY REMOVAL

(71) Applicant: ENTEGRIS, INC., Billerica, MA (US)

(72) Inventors: Christopher Brown, Toronto (CA); Janeth C. Sarmiento Arellano, Oshawa (CA); Sepideh Rezaei, North York (CA)

(21) Appl. No.: 19/373,618

(22) Filed: Oct. 29, 2025

Related U.S. Application Data
(60) Provisional application No. 63/713,493, filed on Oct. 29, 2024.

(51) Int. Cl. C07F 7/02; B01J 47/02; B01J 47/12

(52) U.S. Cl. CPC C07F 7/025; B01J 47/02; B01J 47/12

(57) ABSTRACT

Compositions and methods for impurity removal are provided. A method comprises obtaining a first solution comprising an amino silane compound and a halide impurity. The method comprises contacting the first solution with an anion exchange resin to obtain a second solution. The second solution comprises less of the halide impurity than the first solution.

### CROSS-REFERENCE TO RELATED APPLICATIONS

This application claims the benefit under 35 USC 119 of U.S. Provisional Patent Application Nos. 63/713,493, filed Oct. 29, 2024, the disclosure of which is hereby incorporated herein by reference in its entirety.

### FIELD

The present disclosure relates to exchange resins for impurity removal, and related systems, related compositions, and related methods.

### BACKGROUND

Presence of impurities in solutions can hinder performance and result in other under undesirable effects. Removal of impurities from solutions to obtain compositions with very low impurity levels remains an ongoing challenge.

### SUMMARY

Some embodiments relate to a method. In some embodiments, the method comprises obtaining a first solution. In some embodiments, the first solution comprises an amino silane compound and a halide impurity. In some embodiments, the method comprises contacting the first solution with an anion exchange resin to obtain a second solution. In some embodiments, the second solution comprises less of the halide impurity than the first solution.

Some embodiments relate to a composition. In some embodiments, the composition comprises an amino silane compound of the formula:

SiH_{y}[NR_{z}H_{2-z}]_{4-y},
where:
R is independently an alkyl;
y is 0 to 4; and
z is 0 to 2.

In some embodiments, the composition comprises less than 5 ppm of a halide impurity.

### BRIEF DESCRIPTION OF THE DRAWINGS

FIG. 1 is a flowchart of a method for impurity removal, according to some embodiments.

FIG. 2 is a graphical view illustrating the effects of different ratios of anion exchange resin to amino silane compound, according to some embodiments.

### DETAILED DESCRIPTION

As used herein, the term “contacting” refers to bringing two or more components into immediate or close proximity, or into direct contact.

As used herein, the term “alkyl” refers to a hydrocarbyl having from 1 to 30 carbon atoms. The alkyl may be attached via a single bond. An alkyl having n carbon atoms may be designated as a “Cₙ alkyl.” For example, a “C₃ alkyl” may include n-propyl and isopropyl. An alkyl having a range of carbon atoms, such as 1 to 30 carbon atoms, may be designated as a C₁-C₃₀ alkyl. In some embodiments, the alkyl is linear. In some embodiments, the alkyl is branched. In some embodiments, the alkyl is substituted. In some embodiments, the alkyl is unsubstituted. In some embodiments, the term “alkyl” refers generally to alkyls, alkenyls, alkynyls, and/or cycloalkyls.

As used herein, the term “halide” refers to a —Cl, —Br, —I, or —F.

Conventional methods for removal of impurities, such as, for example, chloride impurities, from compositions comprising amino silanes are not able to achieve sufficiently low chloride impurity levels. For example, efforts to optimize conventional processes for chloride removal are not able to achieve sufficiently low chloride impurity levels. Conventional filtration similarly is not able to achieve sufficiently low chloride impurity levels. In addition, the reaction may reverse to form intermediates that cannot be removed by filtration. Issues with the volatility of some chloride impurities also prevents distillation or other similar processes from being useful for achieving sufficiently low chloride impurity levels.

Some embodiments overcome at least these challenges associated with conventional approaches to impurity removal. In some embodiments, an ion exchange resin, such as, for example and without limitation, an anion exchange resin is useful for removing impurities from compositions comprising amino silane compounds. In some embodiments, the methods disclosed herein can achieve an impurity level that is an order of magnitude lower than an impurity level achieved via conventional methods. In some embodiments, the methods disclosed herein can remove a halide impurity from a composition comprising an amino silane compound such that the composition comprises less than 5 ppm of the halide impurity. Some embodiments provide compositions comprising an amino silane compound and less than 5 ppm of the halide impurity. Other embodiments and advantages are provided elsewhere herein.

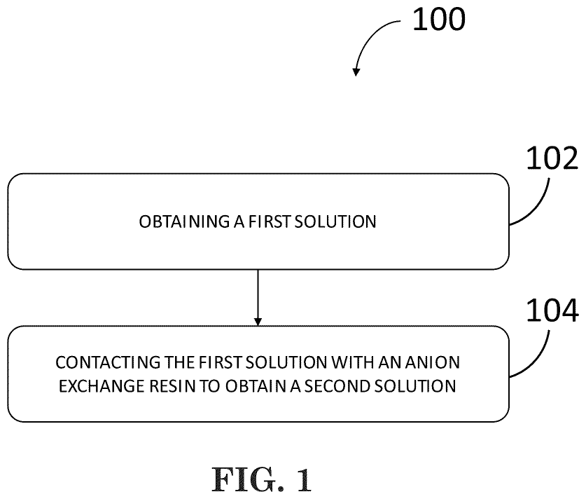

FIG. 1 is a flow diagram of a method for contacting anion exchange resin to remove halide impurity, according to some embodiments. As shown in FIG. 1, the method 100 for contacting an anion exchange resin to remove halide impurity comprises one or more of the following steps: obtaining 102 a first solution comprising an amino silane compound and a halide impurity; and contacting 104 the first solution with an anion exchange resin to obtain a second solution. The second solution may comprise less of the halide impurity than the first solution. Although not shown, in some embodiments, the method 100 comprises removing an anion from the second solution, wherein the anion originated from the anion exchange resin.

At step 102, in some embodiments, the method 100 comprises obtaining a first solution comprising an amino silane compound and a halide impurity.

In some embodiments, the amino silane compound comprises a compound of the formula:

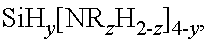

where:
R is independently an alkyl;
y is 0 to 4; and
z is 0 to 2.

In some embodiments, y is 0 and z is 0. In some embodiments, y is 0 and z is 1. In some embodiments, y is 0 and z is 2.

In some embodiments, y is 1 and z is 0. In some embodiments, y is 1 and z is 1. In some embodiments, y is 1 and z is 2.

In some embodiments, y is 2 and z is 0. In some embodiments, y is 2 and z is 1. In some embodiments, y is 2 and z is 2.

In some embodiments, y is 3 and z is 0. In some embodiments, y is 3 and z is 1. In some embodiments, y is 3 and z is 2.

In some embodiments, y is 4.

In some embodiments, the alkyl comprises at least one of a C₁-C₃₀ alkyl, C₁-C₂₉ alkyl, C₁-C₂₈ alkyl, C₁-C₂₇ alkyl, C₁-C₂₇ alkyl, C₁-C₂₆ alkyl, C₁-C₂₅ alkyl, C₁-C₂₄ alkyl, C₁-C₂₃ alkyl, C₁-C₂₂ alkyl, C₁-C₂₁ alkyl, C₁-C₂₀ alkyl, C₁-C₁₉ alkyl, C₁-C₁₈ alkyl, C₁-C₁₇ alkyl, C₁-C₁₆ alkyl, C₁-C₁₅ alkyl, C₁-C₁₄ alkyl, C₁-C₁₃ alkyl, C₁-C₁₂ alkyl, C₁-C₁₁ alkyl, C₁-C₁₀ alkyl, a C₁-C₉ alkyl, a C₁-C₈ alkyl, a C₁-C₇ alkyl, a C₁-C₆ alkyl, a C₁-C₅ alkyl, a C₁-C₄ alkyl, a C₁-C₃ alkyl, a C₁-C₂ alkyl, a C₂-C₃₀ alkyl, a C₃-C₃₀ alkyl, a C₄-C₃₀ alkyl, a C₅-C₃₀ alkyl, a C₆-C₃₀ alkyl, a C₇-C₃₀ alkyl, a C₈-C₃₀ alkyl, a C₉-C₃₀ alkyl, a C₁₀-C₃₀ alkyl, a C₁₁-C₃₀ alkyl, a C₁₂-C₃₀ alkyl, a C₁₃-C₃₀ alkyl, a C₁₄-C₃₀ alkyl, a C₁₅-C₃₀ alkyl, a C₁₆-C₃₀ alkyl, a C₁₇-C₃₀ alkyl, a C₁₈-C₃₀ alkyl, a C₁₉-C₃₀ alkyl, a C₂₀-C₃₀ alkyl, a C₂₁-C₃₀ alkyl, a C₂₂-C₃₀ alkyl, a C₂₃-C₃₀ alkyl, a C₂₄-C₃₀ alkyl, a C₂₅-C₃₀ alkyl, a C₂₆-C₃₀ alkyl, a C₂₇-C₃₀ alkyl, a C₂₈-C₃₀ alkyl, a C₂₉-C₃₀ alkyl, a C₂-C₁₀ alkyl, a C₃-C₁₀ alkyl, a C₄-C₁₀ alkyl, a C₅-C₁₀ alkyl, a C₆-C₁₀ alkyl, a C₇-C₁₀ alkyl, a C₈-C₁₀ alkyl, a C₂-C₉ alkyl, a C₂-C₅ alkyl, a C₂-C₇ alkyl, a C₂-C₆ alkyl, a C₂-C₅ alkyl, a C₃-C₅ alkyl, or any combination thereof. In some embodiments, the alkyl comprises at least one of methyl, ethyl, n-propyl, 1-methylethyl (iso-propyl), n-butyl, iso-butyl, sec-butyl, n-pentyl, 1,1-dimethylethyl (t-butyl), n-pentyl, iso-pentyl, n-hexyl, isohexyl, 3-methylhexyl, 2-methylhexyl, heptyl, octyl, nonyl, decyl, dodecyl, octadecyl, or any combination thereof.

Non-limiting examples of the amino silane compound include, for example and without limitation, at least one of a (bis(tertbutylamino)silane (BTBAS), bis(diethylamino)silane (BDEAS), tris(dimethylamino)silane (TDMAS), or any combination thereof. In some embodiments, the amino silane compound comprises bis(tertbutylamino)silane (BTBAS). In some embodiments, the amino silane compound comprises bis(diethylamino)silane (BDEAS). In some embodiments, the amino silane compound comprises tris(dimethylamino)silane (TDMAS).

In some embodiments, the halide impurity comprises a halide compound. In some embodiments, the halide impurity comprises a halide anion. In some embodiments, the halide impurity comprises a compound of the formula:

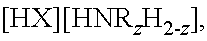

where:
X is a halide;
R is independently an alkyl; and
z is 0 to 2.

In some embodiments, z is 0.

In some embodiments, z is 1.

In some embodiments, z is 2.

In some embodiments, the halide impurity comprises a halide ion (e.g., in solution). In some embodiments, for example, the halide impurity comprises at least one of a chloride ion (Cl⁻), a fluoride ion (F⁻), a bromide ion (Br⁻), an iodide ion (I⁻), or any combination thereof. In some embodiments, the halide impurity comprises the compound of the formula [HX][HNR_{z}H_{2-z}], wherein the compound is disassociated, dissolved, solubilized, etc. in solution.

At step 104, in some embodiments, the method 100 comprises contacting the first solution with an anion exchange resin to obtain a second solution. The second solution may comprise less of the halide impurity than the first solution.

In some embodiments, the contacting comprises bringing the first solution and the anion exchange resin into close or immediate proximity. In some embodiments, the contacting comprises bringing the halide impurity and the anion exchange resin into close or immediate proximity. In some embodiments, the contacting comprises bringing the first solution and the anion exchange resin into direct physical contact. In some embodiments, the contacting comprises bringing the halide impurity and the anion exchange resin into direct physical contact. In some embodiments, the contacting comprises adding the anion exchange resin to the first solution, or vice versa. In some embodiments, the contacting comprises mixing the first solution and the anion exchange resin. In some embodiments, the contacting comprises stirring the first solution and the anion exchange resin. In some embodiments, the contacting comprises agitating the first solution and the anion exchange resin. In some embodiments, the contacting comprises flowing the first solution through a column containing the anion exchange resin. In some embodiments, the contacting comprises flowing the first solution over a bed of the anion exchange resin. In some embodiments, the contacting comprises passing the first solution through a bed of the anion exchange resin. In some embodiments, the contacting proceeds under conditions sufficient for removing at least a portion of the halide impurity from the first solution and to obtain the second solution.

In some embodiments, the contacting comprises exchanging the halide impurity for an anion of the anion exchange resin. In some embodiments, the contacting comprises binding the halide impurity to the anion exchange resin. In some embodiments, the contacting comprises removing the halide impurity from the first solution. In some embodiments, the contacting comprises displacing an anion from the anion exchange resin. In some embodiments, the contacting comprises disassociating an anion from the anion exchange resin. In some embodiments, the contacting comprises breaking a bond located between an anion and the anion exchange resin. In some embodiments, the contacting comprises extracting the halide impurity from the first solution. In some embodiments, the contacting comprises releasing an anion from the anion exchange resin. In some embodiments, the contacting is sufficient for the halide impurity to bond to the anion exchange resin. In some embodiments, the bond comprises an ionic bond. In some embodiments, the bond comprises a covalent bond. In some embodiments, the bond comprises a non-covalent bond. In some embodiments, the bond comprises an intermolecular bond. In some embodiments, the bond comprises Van der Waals forces. In some embodiments, the bond comprises London dispersion forces. In some embodiments, the bond comprises hydrogen bonding. In some embodiments, the bond comprises physical bond.

In some embodiments, the contacting is sufficient to remove 1% to 99% by weight of the halide impurity from the first solution, or any range or subrange between 1% and 99%. For example, in some embodiments, the contacting is sufficient to remove 1% to 90%, 1% to 80%, 1% to 70%, 1% to 60%, 1% to 50%, 1% to 40%, 1% to 30%, 1% to 20%, 1% to 10%, 10% to 99%, 20%, to 99%, 30% to 99%, 40% to 99%, 50% to 99%, 60% to 99%, 70% to 99%, 80% to 99%, or 90% to 99%.

In some embodiments, the anion exchange resin comprises a strongly basic anion exchange resin.

In some embodiments, an exchange resin is a strongly basic anion exchange resin when the exchange resin has a pKa value of greater than 8. In some embodiments, an exchange resin is not a strongly basic anion exchange resin (i.e., a weakly basic anion exchange resin) when the exchange resin exhibits a pKa value of 5 to 8. In some embodiments, an exchange resin is a strongly basic anion exchange resin when the exchange resin is protonated over the entire pH range, whereas an exchange resin is a weakly basic anion exchange resin when the exchange resin is protonated at pH in a range of 5 to 8. In some embodiments, an exchange resin is a strongly basic anion exchange resin when the exchange resin is capable of exchanging anions in both acidic solutions and alkaline solutions. In some embodiments, the anion associated with the polymer is strongly basic. In some embodiments, an anion exchange resin may be a strongly basic anion exchange resin, when the anion exchange resin maintains a negative charge across a wide pH range, such as, for example and without limitation, a pH range of 0 to 14, 0 to 13, 0 to 12, 0 to 11, 0 to 10, 0 to 9, 0 to 8, 0 to 7, 0 to 6, 0 to 5, 0 to 4, 0 to 3, 0 to 2, 0 to 1, 1 to 14, 2 to 14, 3 to 14, 4 to 14, 5 to 14, 6 to 14, 7 to 14, 8 to 14, 9 to 14, 10 to 14, 11 to 14, 12 to 14, 13 to 14, or any range or subrange between 0 and 14.

In some embodiments, the anion exchange resin comprises a quaternary ammonium group. In some embodiments, the anionic exchange resin is a tertiary amine anion exchange resin. In some embodiments, the amine anion exchange resin comprises at least one of tertiary-aminated styrene-divinylbenzene copolymers, tertiary-aminated crosslinked styrene polymers, tertiary-aminated phenol-formaldehyde resins, tertiary-aminated benzene-formaldehyde resins, or any combination thereof. In some embodiments, the anionic exchange resin comprises a quaternary amine anion exchange resin. In some embodiments, the anionic exchange resin comprises a quaternary amine anion exchange resin and at least one other anion exchange resin.

In some embodiments, the anion exchange resin comprises a polymer. In some embodiments the anion exchange resin comprises a crosslinked polymer. In some embodiments, the polymer and/or the crosslinked polymer comprises at least one of styrene units, vinyl units, divinylbenzene units, acrylic units, or any combination thereof. In some embodiments, the anion exchange resin comprises a styrene-divinylbenzene copolymer. In some embodiments, the anion exchange resin comprises a cross-linked styrene-divinylbenzene copolymer. In some embodiments, the anion exchange resin further comprises a quaternary ammonium group.

In some embodiments, the anion exchange resin comprises an anion. In some embodiments, the anion is associated with the polymer. In some embodiments, the anion is associated with the crosslinked polymer. In some embodiments, the anion comprises at least one of a hydroxide anion (—OH), a halide (e.g., Cl, Br, F, and/or I), or any combination thereof.

In some embodiments, the anion exchange resin may be provided in a form of a particle. In some embodiments, the anion exchange resin may be provided in a form of a particle having an average particle size of 10 μm to 500 μm, or any range or subrange between 10 μm to 500 μm. In some embodiments, the average particle size comprises 50 μm to 500 μm; 100 μm to 500 μm; 150 μm to 500 μm; 200 μm to 500 μm; 250 μm to 500 μm; 300 μm to 500 μm; 350 μm to 500 μm; 400 μm to 500 μm; 450 μm to 500 μm; 10 μm to 450 μm; 10 μm to 400 μm; 10 μm to 350 μm; 10 μm to 300 μm; 10 μm to 250 μm; 10 μm to 200 μm; 10 μm to 150 μm; 10 μm to 100 μm; or 10 μm to 50 μm.

In some embodiments, the anion exchange resin is provided in a form of a membrane. Membranes may be useful for removing contaminants from a first solution.

Some embodiments relate to a composition. In some embodiments, the composition comprises an amino silane compound of the formula:

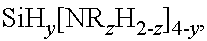

where:
R is independently an alkyl;
y is 0 to 4; and
z is 0 to 2.

The composition may comprise an amino silane compound.

In some embodiments, the composition comprises less than 10 ppm of a halide impurity. In some embodiments, the composition comprises less than 8 ppm of a halide impurity. In some embodiments, the composition comprises less than 7 ppm of a halide impurity. In some embodiments, the composition comprises less than 6 ppm of a halide impurity. In some embodiments, the composition comprises less than 5 ppm of a halide impurity. In some embodiments, the composition comprises less than 4 ppm of a halide impurity. In some embodiments, the composition comprises less than 3 ppm of a halide impurity. In some embodiments, the composition comprises less than 2 ppm of a halide impurity. In some embodiments, the composition comprises less than 1 ppm of a halide impurity.

In some embodiments, the composition comprises 0.01 ppm to 5 ppm of a halide impurity, or any range or subrange between 0.01 and 5. In some embodiments, the composition comprises 0.1 ppm to 5 ppm, 0.5 ppm to 5 ppm, 1 ppm to 5 ppm, 2 ppm to 5 ppm, 3 ppm to 5 ppm, 4 ppm to 5 ppm, 0.01 ppm to 4 ppm, 0.01 ppm to 3 ppm, 0.01 ppm to 2 ppm, 0.01 ppm to 1 ppm, 0.5 ppm to 5 ppm, 0.5 ppm to 4 ppm, 0.5 ppm to 3 ppm, 0.5 ppm to 2 ppm, or 0.5 ppm to 1 ppm.

In some embodiments, the halide impurity comprises a halide compound. In some embodiments, the halide impurity comprises a halide anion. In some embodiments, the halide impurity comprises a compound of the formula:

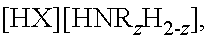

where:
X is a halide;
R is independently an alkyl; and
z is 0 to 2.

The composition described herein, may be used to remove a halide impurity.

The present disclosure for removal of halide impurity in the first solution comprises the following general formula:

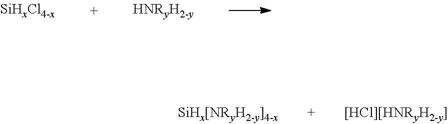

Non-limiting examples of such application of the general formula using BDEAS as the amino silane compound comprises the following formula:

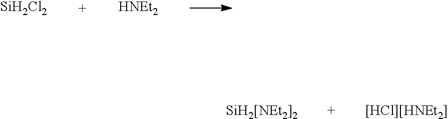

### EXAMPLE 1

A commercially available anion exchange resin containing hydroxide anions was contacted with a solution comprising bis(diethylamino)silane (BDEAS). The relative amounts of the BDEAS and the anion exchange resin were varied, and the resulting chloride content, as well as the amount of absorbed chloride (i.e., on the anion exchange resin after contacting) was measured. The chloride content of a control was also measured, where the control did not involve contacting with the anion exchange resin. The amount of BDEAS (g), the amount of anion exchange resin (g), the weight ratio of the anion exchange resin:BDEAS, the chloride content (ppm), the chloride absorbed (ppm), and the percent of Cl absorbed are summarized in Table 1 below.

TABLE 1

| | | | Anion | | | |
|---|---|---|---|---|---|---|
| | | Anion | Exchange | | Cl | |
| | | Exchange | Resin:BDEAS | | Absorbed | % Cl |
| Sample | BDEAS (g) | Resin (g) | (w/w %) | Cl (ppm) | (ppm) | Absorbed |
| Control | 5.0 | 0.0 | 0.0 | 7.5 | 0.0 | 0% |
| 1 | 8.5 | 0.2 | 2.0 | 2.3 | 5.2 | 69% |
| 2 | 8.5 | 0.4 | 5.0 | 2.5 | 5.0 | 67% |
| 3 | 8.8 | 0.5 | 6.0 | 2.2 | 5.3 | 71% |
| 4 | 9800.0 | 640.0 | 7.0 | 0.5 | 7.0 | 78% |

As shown in Table 1, Samples 1 to 4 removed significant amounts of the chloride ions relative to the control, which was several orders of magnitude greater than Samples 1 to 4.

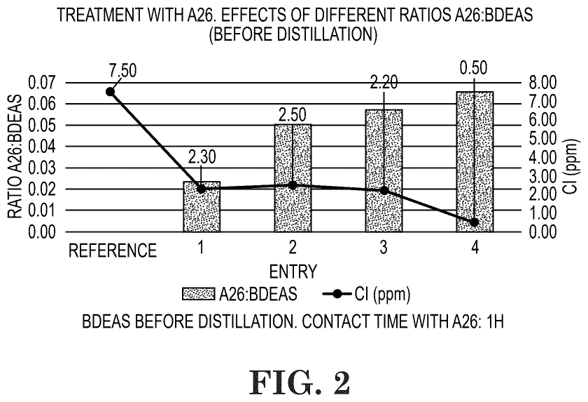

FIG. 2 is graphical view illustrating the effects of different ratios of anion exchange resin to amino silane compound, according to some embodiments. FIG. 2 is a bar graph of the data provided in Table 1.

### Aspects

Various Aspects are described below. It is to be understood that any one or more of the features recited in the following Aspect(s) can be combined with any one or more other Aspect(s).

Aspect 1. A method comprising:
obtaining a first solution comprising an amino silane compound and a halide impurity; and
contacting the first solution with an anion exchange resin to obtain a second solution,
   wherein the second solution comprises less of the halide impurity than the first solution.

Aspect 2. The method according to Aspect 1, wherein the anion exchange resin comprises a hydroxide anion that exchanges with the halide impurity.

Aspect 3. The method according to any one of Aspects 1-2, wherein the anion exchange resin comprises a polymer and an anion associated with the polymer.

Aspect 4. The method according to any one of Aspects 1-3, wherein the anion exchange resin comprises a crosslinked polymer and an anion associated with the crosslinked polymer.

Aspect 5. The method according to any one of Aspects 1-4, wherein the anion exchange resin is provided in a form of a particle.

Aspect 6. The method according to any one of Aspects 1-5, wherein the anion exchange resin is provided in a form of a particle having an average particle size of 10 μm to 500 μm.

Aspect 7. The method according to any one of Aspects 1-6, wherein the anion exchange resin is provided in a form of a membrane.

Aspect 8. The method according to any one of Aspects 1-7, wherein the amino silane compound comprises a compound of the formula:

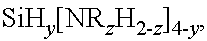

where:
   R is independently an alkyl;
   y is 0 to 4; and
   z is 0 to 2.

Aspect 9. The method according to any one of Aspects 1-8, wherein the amino silane compound comprises bis(diethylamino)silane.

Aspect 10. The method according to any one of Aspects 1-9, wherein the halide impurity comprises a compound of the formula:

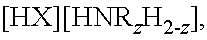

where:
   X is a halide;
   R is independently an alkyl; and
   z is 0 to 2.

Aspect 11. The method according to any one of Aspects 1-10, wherein the anion exchange resin is present in an amount of 1% to 10% by weight based on a total weight of the anion exchange resin and the amino silane compound.

Aspect 12. The method according to any one of Aspects 1-11, wherein the second solution comprises less than 5 ppm of the halide impurity.

Aspect 13. The method according to any one of Aspects 1-12, wherein the second solution comprises less than 2 ppm of the halide impurity.

Aspect 14. The method according to any one of Aspects 1-13, wherein the second solution comprises less than 1 ppm of the halide impurity.

Aspect 15. A composition comprising:
an amino silane compound of the formula:

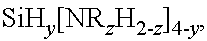

where:
   R is independently an alkyl;
      y is 0 to 4; and
      z is 0 to 2;
wherein the composition comprises less than 5 ppm of a halide impurity.

Aspect 16. The composition according to Aspect 15, wherein the halide impurity comprises a compound of the formula:

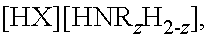

where:
   X is a halide;
   R is independently an alkyl; and
   z is 0 to 2.

Aspect 17. The composition according to any one of Aspects 15-16, wherein the amino silane compound comprises bis(diethylamino)silane.

Aspect 18. The composition according to any one of Aspects 15-17, wherein the composition comprises less than 5 ppm of the halide impurity.

Aspect 19. The composition according to any one of Aspects 15-18, wherein the composition comprises less than 2 ppm of the halide impurity.

Aspect 20. The composition according to any one of Aspects 15-19, wherein the composition comprises less than 1 ppm of the halide impurity.

What is claimed is:

1. A method comprising:
obtaining a first solution comprising an amino silane compound and a halide impurity; and
contacting the first solution with an anion exchange resin to obtain a second solution,
wherein the second solution comprises less of the halide impurity than the first solution.

2. The method of claim 1, wherein the anion exchange resin comprises a hydroxide anion that exchanges with the halide impurity.

3. The method of claim 1, wherein the anion exchange resin comprises a polymer and an anion associated with the polymer.

4. The method of claim 1, wherein the anion exchange resin comprises a crosslinked polymer and an anion associated with the crosslinked polymer.

5. The method of claim 1, wherein the anion exchange resin is provided in a form of a particle.

6. The method of claim 1, wherein the anion exchange resin is provided in a form of a particle having an average particle size of 10 μm to 500 μm.

7. The method of claim 1, wherein the anion exchange resin is provided in a form of a membrane.

8. The method of claim 1, wherein the amino silane compound comprises a compound of the formula: 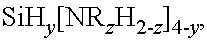
where:
R is independently an alkyl;
y is 0 to 4; and
z is 0 to 2.

9. The method of claim 1, wherein the amino silane compound comprises bis(diethylamino)silane.

10. The method of claim 1, wherein the halide impurity comprises a compound of the formula: 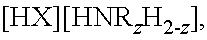
where:
X is a halide;
R is independently an alkyl; and
z is 0 to 2.

11. The method of claim 1, wherein the anion exchange resin is present in an amount of 1% to 10% by weight based on a total weight of the anion exchange resin and the amino silane compound.

12. The method of claim 1, wherein the second solution comprises less than 5 ppm of the halide impurity.

13. The method of claim 1, wherein the second solution comprises less than 2 ppm of the halide impurity.

14. The method of claim 1, wherein the second solution comprises less than 1 ppm of the halide impurity.

15. A composition comprising:
an amino silane compound of the formula: 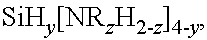
where:
R is independently an alkyl;
y is 0 to 4; and
z is 0 to 2;
wherein the composition comprises less than 5 ppm of a halide impurity.

16. The composition of claim 15, wherein the halide impurity comprises a compound of the formula: 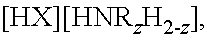
where:
X is a halide;
R is independently an alkyl; and
z is 0 to 2.

17. The composition of claim 15, wherein the amino silane compound comprises bis(diethylamino)silane.

18. The composition of claim 15, wherein the composition comprises less than 5 ppm of the halide impurity.

19. The composition of claim 15, wherein the composition comprises less than 2 ppm of the halide impurity.

20. The composition of claim 15, wherein the composition comprises less than 1 ppm of the halide impurity.
